(19) United States
(12) Patent Application Publication
(10) Pub. No.: US 2025/0263581 A1
(43) Pub. Date: Aug. 21, 2025

(54) ACTIVE ENERGY RAY CURABLE SILICONE COMPOSITION AND CURED PRODUCT THEREOF

(71) Applicant: DOW SILICONES CORPORATION, Midland, MI (US)

(72) Inventors: Juyoung YOOK, Chungcheongbuk-Do (KR); Nanguo LIU, Midland, MI (US)

(21) Appl. No.: 18/859,516

(22) PCT Filed: Apr. 25, 2023
(86) PCT No.: PCT/US2023/019709

§ 371 Date: Oct. 23, 2024

Related U.S. Application Data
(60) Provisional application No. 63/334,824, filed on Apr. 26, 2022.

(51) Int. Cl. C09D 183/14; C08G 77/00; C08G 77/12; C08G 77/20; C08G 77/52; C09D 183/06

(52) U.S. Cl. CPC C09D 183/14; C08G 77/12; C08G 77/20; C08G 77/52; C09D 183/06; C08G 77/80

(57) ABSTRACT

An active energy ray curable silicone composition, comprising: (A) an organopolysiloxane resin having an alkenyl group in a molecule; (B) an organosiloxane oligomer having a viscosity at 25° C. of not more than 1,000 mPa·s, at least one silicon atom-bonded alkenyl group or silicon atom-bonded hydrogen atom, and at least one silicon atom-bonded aryl group in a molecule; (C) optionally, an organosilicon compound selected from (C₁) an organopolysiloxane having at least one alkenyl group and not having a silicon atom-bonded aryl group and SiO_{4/2} unit in a molecule, (C₂) an organopolysiloxane having at least one silicon atom-bonded hydrogen atom and not having a silicon atom-bonded aryl group in a molecule, (C₃) a disilylbenzene, and mixtures thereof; (D) an organosilicon compound having at least one silicon atom-bonded acryloxyalkyl group or silicon atom-bonded methacryloxyalkyl group, and at least one silicon atom-bonded hydrogen atom in a molecule; and (E) a hydrosilylation reaction catalyst.

### CROSS-REFERENCE TO RELATED APPLICATIONS

This application claims priority to and all advantages of U.S. Provisional Patent Application No. 63/334,824 filed on 26 Apr. 2022, the content of which is incorporated herein by reference.

### TECHNICAL FIELD

The present invention relates to an active energy ray curable silicone composition and a cured product thereof.

### BACKGROUND

Heat curable, moisture curable, or active energy ray curable silicone compositions have been used in a wide range of industrial fields since these curable silicone compositions cure to form cured products having excellent heat resistance, cold resistance, electrical insulating properties, weatherability, water repellency, and transparency. In particular, the cured products thereof are less likely to be discolored compared to other organic materials, and the cured products cause less degradation of physical properties. Therefore, the cured products are suitable as optical materials.

For example, Patent Document 1 proposes a liquid silicone resin composition for optoelectronic devices, comprising: an alkenyl group-containing silicone resin, a silicon atom-bonded hydrogen atom-containing organopolysiloxane, and a hydrosilylation reaction catalyst.

Meanwhile, materials that are solid or semisolid at a room temperature have been proposed for production processes for optoelectronic devices in recent years. Silicone hot-melt compositions have been reported, for example. Such silicone hot-melt compositions mainly contain an organically modified polysilicate resin, which is a non-flowable solid at a room temperature, consisting essentially of organosilicate (T) units (i.e., RSiO_{3/2} units, in which R denotes a monovalent organic group, for example, methyl or phenyl) and/or silicate (Q) units (i.e., SiO_{4/2} units), and further contain linear organopolysiloxane and crosslinkers.

For example, Patent Document 2 proposes an active energy ray curable hot-melt silicone composition comprising: a high amount (approximately 80 wt. %) of organically modified polysilicate resin (MQ resin), and linear organopolysiloxanes, mercapto-functional crosslinkers, and photoradical initiators, which is a solid or semisolid at room temperature, and melted at high temperature; Patent Document 3 proposes an addition curable adhesive silicone composition, comprising vinyl (Vi) group and hydrosilyl (SiH) group-containing organopolysilicate resin (MT resin), which is a solid or a semisolid in an uncured state at a room temperature; and Patent Documents 4 and 5 propose solvent-based hot-melt compositions via metal-catalyzed pre-reaction of vinyl-containing organo-modified polysilicate resins and hydrosilyl-modified linear polysiloxane in solvent (such as toluene), and their melting and further crosslinking with additional multifunctional hydrosilyl crosslinkers is conducted at elevated temperature.

However, such above non-flowable silicone hot-melt composition at a room temperature or solvent-based flowable hot-melt composition is not suitable to fabricate hot-melt film (or layer or sheet) because a precise control of temperature to melt and reduce viscosity of silicone hot-melt composition is required to obtain uniform silicone hot-melt film via hot-melt coating process, as well as to avoid premature cure (further hydrosilylation crosslinking) at elevated temperature during coating process. Moreover, in case of solvent-based silicone composition, it is suitable for coating process, however, it is difficult to control thickness and to obtain thick (200-500 μm) hot-melt film due to inefficient solvent drying.

### PRIOR ART DOCUMENTS

### Patent Documents

Patent Document 1: U.S. Patent Application Publication No. US 2004/0116640 A1
Patent Document 2: U.S. Patent Application Publication No. US 2018/0305547 A1
Patent Document 3: U.S. Patent Application Publication No. US 2008/0308828 A1
Patent Document 4: U.S. Patent Application Publication No. US 2018/0208816 A1
Patent Document 5: U.S. Patent Application Publication No. US 2017/0355804 A1

### SUMMARY OF THE INVENTION

### Technical Problem

An object of the present invention is to provide an active energy ray curable silicone composition which has an excellent handleability without using a solvent, cures by heat to form a less- or non-sticky pre-cured product at room temperature with an excellent melt viscosity by heating, and cures further by an active energy ray to form a cured product which no longer has a hot-melt property.

### Solution to Problem

The active energy ray curable silicone composition of the present invention comprises:
(A) an organopolysiloxane resin represented by the following average unit formula:

(R¹₃SiO_{1/2})ₐ(R²R¹₂SiO_{1/2})_{b}(SiO_{4/2})_{c}(HO_{1/2})_{d}
wherein each R¹ is independently an alkyl group; R² is an alkenyl group; and subscripts a, b, c and d are numbers satisfying the following conditions: a≥0, b>0, 0.3≤c≤0.7, 0≤d≤0.05, and a +b+c=1;
(B) an organosiloxane oligomer having a viscosity at 25° C. of not more than 1,000 mPa·s, and selected from the group consisting of (B₁) an organosiloxane oligomer having at least one silicon atom-bonded alkenyl group and at least one silicon atom-bonded aryl group in a molecule, (B₂) an organosiloxane oligomer having at least one silicon atom-bonded hydrogen atom and at least one silicon atom-bonded aryl group in a molecule, and a mixture of components (B₁) and (B₂);
(C) optionally, an organosilicon compound selected from the group consisting of (C₁) an organopolysiloxane having at least one alkenyl group and not having a silicon atom-bonded aryl group and SiO_{4/2} unit in a molecule, (C₂) an organopolysiloxane having at least one silicon atom-bonded hydrogen atom and not having a silicon atom-bonded aryl group in a molecule, (C₃) a disilylbenzene represented by the following general formula:

HR¹₂Si—C₆H₄—SiR¹₂H
wherein each R¹ is as described above, and mixtures thereof;
(D) an organosilicon compound having at least one silicon atom-bonded acryloxyalkyl group or silicon atom-bonded methacryloxyalkyl group, and at least one silicon atom-bonded hydrogen atom in a molecule; and
(E) a catalytic amount of a hydrosilylation reaction catalyst;
wherein an amount of component (A) is in a range of from 50 to 80 mass %, an amount of component (B) is in a range of from 5 to 40 mass %, an amount of component (C) is in a range of from 0 to 30 mass %, each based on a total mass of components (A) to (C), and an amount of component (D) is in a range of from 2 to 20 parts by mass relative to 100 parts by mass of a total mass of components (A) to (C), with the proviso that a molar ratio of all silicon atom-bonded hydrogen atoms relative to all silicon atom-bonded alkenyl groups in components (A) to (D) is 0.5 or more and less than 1.0.

In various embodiments, component (B₁) is at least one selected from (B₁₁) an organosiloxane oligomer represented by the following general formula:

R²R³₂SiO(R³₂SiO)ₘSiR³₂R²
wherein each R² is independently an alkenyl group; each R³ is independently an alkyl group or an aryl group, with the proviso that at least one R³ is an aryl group; and subscript m is an integer of 0 to 10.

In various embodiments, component (B₁₁) is at least one selected from organosiloxane oligomers represented by the following formulas:

(CH₂═CH)(CH₃)₂SiO(C₆H₅)₂SiOSi(CH₃)₂(CH═CH₂);

(CH₂═CH)(CH₃)₂SiO(C₆H₅)(CH₃)SiOSi(CH₃)₂(CH═CH₂); and

(CH₂═CH)(CH₃)(C₆H₅)SiOSi(CH₃)(C₆H₅)(CH═CH₂).

In various embodiments, component (B₂) is at least one selected from (B₂₁) an organosiloxane oligomer represented by the following general formula:

HR³₂SiO(R³₂SiO)ₘSiR³₂H

wherein each R³ is independently an alkyl group or an aryl group, with the proviso that at least one R³ is an aryl group; and subscript m is an integer of 0 to 10.

In various embodiments, component (B₂₁) is at least one selected from organosiloxane oligomers represented by the following formulas:

H(CH₃)₂SiO(C₆H₅)₂SiOSi(CH₃)₂H; and

H(CH₃)₂SiO(C₆H₅)(CH₃)SiOSi(CH₃)₂H.

In various embodiments, component (D) has the acryloxyalkyl group or methacryloxyalkyl group is represented by the following general formula:

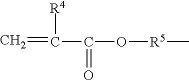

wherein R⁴ is a methyl group or a hydrogen atom; and R⁵ is an alkylene group having 2 to 6 carbon atoms.

In various embodiments, component (D) is at least one organosilicon compound selected from compounds represented by the following general formulas:

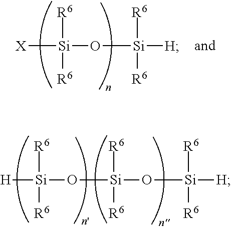

wherein each R⁶ is independently an alkyl group or an aryl group; X is a group represented by the following general formula:

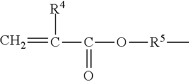

wherein R⁴ is a methyl group or a hydrogen atom, and R⁵ is an alkylene group having 2 to 6 carbon atoms; and subscript n is an integer of 1 to 10, subscript n′ is an integer of 1 to 10, and subscript n″ is an integer of 0 to 10.

In various embodiments, component (D) is used in an amount such that a content of the acryloxyalkyl group or methacryloxyalkyl group is 4 mmol/100 g or more relative to a total mass of components (A) to (E), optionally of components (A) to (G) (where components (F) and (G) are described below).

In various embodiments, the curable silicone composition further comprises: (F) a hydrosilylation reaction inhibitor, in an amount to adjust a curing of the composition.

In various embodiments, the curable silicone composition further comprises: (G) a photoradical initiator, in an amount to accelerate curing of the composition by an active energy ray.

The pre-cured product of the present invention is obtained by hydrosilylation reacting the above-mentioned curable silicone composition.

The cured product of the present invention is obtained by exposing the above-mentioned pre-cured product to an active energy ray.

The method of producing a cured product of the present invention, comprises the following steps:
1) curing the curable silicone composition of the present invention to form a pre-cured product by hydrosilylation reaction;
2) placing the pre-cured product on a target substrate, and applying heat and/or pressure onto the pre-cured product placed on a target substrate; and
3) exposing the pre-cured product to an active energy ray.

### Effects of Invention

The active energy ray curable silicone composition of the present invention has an excellent handleability at a room temperature without using a solvent, and cures by heat to form a less- or non-sticky pre-cured product at room temperature with an excellent melt viscosity by heating, and cures further by an active energy ray to form a cured product which no longer has a hot-melt property.

### Definitions

The terms “comprising” or “comprise” are used herein in their broadest sense to mean and encompass the notions of “including,” “include,” “consist(ing) essentially of,” and “consist(ing) of. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples. The term “about” as used herein serves to reasonably encompass or describe minor variations in numerical values measured by instrumental analysis or as a result of sample handling. Such minor variations may be in the order of ±0-25, ±0-10, ±0-5, or ±0-2.5, % of the numerical values. Further, the term “about” applies to both numerical values when associated with a range of values. Moreover, the term “about” may apply to numerical values even when not explicitly stated.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The term “active energy ray” is used herein as an ultraviolet ray, electron beam, radial ray, and the like. Examples of a device that emits the ultraviolet ray include high-pressure mercury lamps, medium-pressure mercury lamps, and ultraviolet LEDs.

### DETAILED DESCRIPTION OF THE INVENTION

The active energy ray curable silicone composition of the present invention will be explained in detail.

Component (A) is an organopolysiloxane resin represented by the following average unit formula:

(R¹₃SiO_{1/2})ₐ(R²R¹₂SiO_{1/2})_{b}(SiO_{4/2})_{c}(HO_{1/2})_{d}.

In the formula, each R¹ is independently an alkyl group. The alkyl groups are exemplified by alkyl groups with 1 to 12 carbon atoms such as methyl groups, ethyl groups, propyl groups, isopropyl groups, butyl groups, isobutyl groups, tert-butyl groups, pentyl groups, neopentyl groups, hexyl groups, cyclohexyl groups, heptyl groups, octyl groups, nonyl groups, decyl groups, undecyl groups and dodecyl groups. Among these, methyl groups are preferable.

In the formula, R² is an alkenyl group. The alkenyl groups are exemplified by alkenyl groups with 2 to 12 carbon atoms such as vinyl groups, allyl groups, butenyl groups, pentenyl groups, hexenyl groups, heptenyl groups, octenyl groups, nonenyl groups, decenyl groups, undecenyl groups, and dodecenyl groups. Among these, vinyl groups are preferable.

In the formula, subscripts a, b, c and d are numbers satisfying the following conditions: a≥0, b>0, 0.3≤c≤0.7, 0≤d≤0.05, and a+b+c=1, optionally 0.1≤a≤0.5, 0.01≤b≤0.2, 0.4≤c≤0.7, 0≤d≤0.05, and a +b+c=1, or optionally 0.2≤a≤0.5, 0.01≤b≤0.2, 0.4≤c≤0.7, 0≤d≤0.05, and a +b+c=1. This is because, if subscript a, b, c and d are numbers within the ranges mentioned above, a cured product obtained by curing the present composition will have appropriate hardness and mechanical strength.

A molecular weight of the organopolysiloxane resin for component (A) is not limited, however, its number average molecular weight (Mn) measured in terms of standard polystyrene by gel permeation chromatography (GPC) is preferably at least 1,500 g/mol, alternatively at least 2,000 g/mol, or alternatively at least 3,000 g/mol; while at the same time the Mn is preferably not more than 6,000 g/mol; alternatively not more than 5,500 g/mol. The Mn of component (A) can be an arbitrary range that combines the upper and lower limits described above. Note that if component (A) is in a solid state at 25° C. and it is difficult to uniformly mix other components in the present composition, such can be resolved by preparing an organic solution of component (A) in advance, and mixing with a portion or all of components (B) and (C), after which the used organic solvent can be removed from this mixture. Note that the organic solvent which can be used to prepare the organic solution of component (A) can be used as long as it can dissolve component (A) and be easily removed. While not limited thereto, specific examples thereof include: aromatic hydrocarbons such as toluene and xylene; and aliphatic hydrocarbons such as hexane and heptane.

Component (A) is used in an amount of from 50 to 80 mass %, alternatively in an amount of from 55 to 80 mass %, or alternatively in an amount of from 55 to 75 mass %, each based on a total mass of components (A) to (C). This is because, if the amount is equal to or above the lower limit of the ranges described above, a cured product obtained by curing the present composition will have a less- or non-sticky surface and appropriate hardness and mechanical strength, whereas if the amount is equal to or below the upper limit of the ranges described above, the composition has suitable viscosity at 25° C.

Component (B) is an organosiloxane oligomer to impart the curable silicone composition with a flowable property, and to impart a cured product obtained by curing the composition with hotmelt property. A molecular structure of the organosiloxane oligomer for component (B) is not limited, however, are exemplified by a straight chain structure, or a partially branched straight-chain structure. Component (B) may be one type of organosiloxane oligomer having these molecular structures or may be a mixture of two or more types of organosilicon compounds having these molecular structures. A molecular weight of the organosiloxane oligomer for component (B) is not limited, however, it is preferably not more than 2,000 g/mol, alternatively not more than 1,500 g/mol. The organosiloxane oligomer typically has a viscosity at 25° C. of not more than 1,000 mPa·s, alternatively not more than 500 mPa·s, or alternatively not more than 100 mPa·s. Note that in the present specification, viscosity is the value measured using a type B viscometer according to ASTM D 1084 at 23±2° C.

The organosiloxane oligomer for component (B) also acts as a chain extending agent or a crosslinking agent for the composition, and is selected from (B₁) an organosiloxane oligomer having at least one silicon atom-bonded alkenyl group and at least one silicon atom-bonded aryl group in a molecule, (B₂) an organosiloxane oligomer having at least one silicon atom-bonded hydrogen atom and at least one silicon atom-bonded aryl group in a molecule, and a mixture of components (B₁) and (B₂).

The organosiloxane oligomer for component (B₁) is typically an organosiloxane oligomer represented by the following general formula:

R²R³₂SiO(R³₂SiO)ₘSiR³₂R².

In the formula, each R² is independently an alkenyl group, and examples thereof include the same groups as those described above. Among these, vinyl groups are preferable.

In the formula, each R³ is independently an alkyl group or an aryl group. Examples of alkyl groups for R³ include the same alkyl groups as R¹ described above. Examples of aryl groups for R³ include aryl groups with 6 to 12 carbon atoms such as phenyl groups, tolyl groups, xylyl groups and naphthyl groups. However, at least one R³ is an aryl group, typically a phenyl group.

In the formula, subscript m is an integer of 0 to 10, alternatively an integer of 0 to 5, alternatively an integer of 0 to 3, or alternatively an integer of 0 or 1.

Component (B₁) is typically at least one selected from organosiloxane oligomers represented by the following formulas:

(CH₂═CH)(CH₃)₂SiO(C₆H₅)₂SiOSi(CH₃)₂(CH═CH₂);

(CH₂═CH)(CH₃)₂SiO(C₆H₅)(CH₃)SiOSi(CH₃)₂(CH═CH₂); and

(CH₂═CH)(CH₃)(C₆H₅)SiOSi(CH₃)(C₆H₅)₂(CH═CH₂).

The organosiloxane oligomer for component (B₂) is typically an organosiloxane oligomer represented by the following general formula:

HR³₂SiO(R³₂SiO)ₘSiR³₂H.

In the formula, each R³ is an alkyl group or an aryl group, and examples thereof include the same groups as those described above. However, at least one R³ is an aryl group, typically a phenyl group.

In the formula, subscript m is an integer of 0 to 10, alternatively an integer of 0 to 5, alternatively an integer of 0 to 3, or alternatively an integer of 0 or 1.

Component (B₂) is typically at least one selected from organosiloxane oligomers represented by the following formulas:

H(CH₃)₂SiO(C₆H₅)₂SiOSi(CH₃)₂H; and

H(CH₃)₂SiO(C₆H₅)(CH₃)SiOSi(CH₃)₂H.

Component (B) is used in an amount of from 5 to 40 mass %, alternatively in an amount of from 10 to 35 mass %, or alternatively in an amount of from 20 to 35 mass %, each based on a total mass of components (A) to (C). This is because, if the amount is equal to or above the lower limit of the ranges described above, the composition has good handleability, and a cured product obtained by curing the present composition will have a less- or non-sticky surface, whereas if the amount is equal to or below the upper limit of the ranges described above, the obtained cured product has good transparency. The organosiloxane oligomer for component (B) may be a mixture of components (B₁) and (B₂). While the amounts of components (B₁) and (B₂) are not limited, the amount of component (B) should be an amount that a molar ratio of all silicon atom-bonded hydrogen atoms relative to all silicon atom-bonded alkenyl groups in components (A) to (D) is 0.5 or more and less than 1.0.

Component (C) is an arbitrary component and an organosilicon compound selected from (C₁) an organopolysiloxane having at least one alkenyl group and not having a silicon atom-bonded aryl group and SiO_{4/2} unit in a molecule, (C₂) an organopolysiloxane having at least one silicon atom-bonded hydrogen atom and not having a silicon atom-bonded aryl group in a molecule, (C₃) a disilylbenzene represented by the following general formula:

HR¹₂Si—C₆H₄—SiR¹₂H

and a mixture thereof. R¹ is as described above.

If a mixture of components (A) and (B) can be cured fully, an addition of component (C) is optional. However, if the mixture cannot be cured for lack of silicon atom-bonded alkenyl groups, component (C₁) should be added, whereas, if the mixture cannot be cured for lack of silicon atom-bonded hydrogen atoms, component (C₂) and/or (C₃) should be added. Furthermore, if the cured product obtained by curing the present composition is hard, component (C) as a chain extending agent should be added, whereas, if the cured product obtained by curing the present composition is soft, component (C) as a crosslinking agent should be added.

Component (C₁) is an organopolysiloxane having at least one alkenyl group and not having a silicon atom-bonded aryl group and SiO_{4/2} unit in a molecule. Examples of the alkenyl groups include alkenyl groups with 2 to 12 carbon atoms such as vinyl groups, allyl groups, butenyl groups, pentenyl groups, hexenyl groups, heptenyl groups, octenyl groups, nonenyl groups, decenyl groups, undecenyl groups and dodecenyl groups. Among these, vinyl groups are preferable. In addition, examples of groups bonding to silicon atoms other than alkenyl groups in component (C₁) include alkyl groups with 1 to 12 carbon atoms such as methyl groups, ethyl groups, propyl groups, isopropyl groups, butyl groups, isobutyl groups, tert-butyl groups, pentyl groups, neopentyl groups, hexyl groups, cyclohexyl groups, heptyl groups, octyl groups, nonyl groups, decyl groups, undecyl groups and dodecyl groups.

A molecular structure of component (C₁) is not limited, but is typically a straight-chain structure, a partially branched straight-chain structure, a branched-chain structure, or a cyclic structure. Component (C₁) may be one type of organopolysiloxane having these molecular structures or may be a mixture of two or more types of organopolysiloxanes having these molecular structures.

Examples of such component (C₁) include dimethylpolysiloxanes capped at both molecular chain terminals with dimethylvinylsiloxy groups, copolymers of dimethylsiloxane and methylvinylsiloxane capped at both molecular chain terminals with dimethylvinylsiloxy groups, copolymers of dimethylsiloxane and methylvinylsiloxane capped at both molecular chain terminals with trimethylsiloxy groups, and mixtures of two or more types thereof.

Component (C₂) is an organopolysiloxane having at least one silicon atom-bonded hydrogen atom and not having a silicon atom-bonded aryl group in a molecule. Examples of groups bonding to silicon atoms in component (C₂) include alkyl groups having from 1 to 12 carbon atoms such as methyl groups, ethyl groups, propyl groups, isopropyl groups, butyl groups, isobutyl groups, tert-butyl groups, pentyl groups, neopentyl groups, hexyl groups, cyclohexyl groups, heptyl groups, octyl groups, nonyl groups, decyl groups, undecyl groups and dodecyl groups.

A molecular structure of component (C₂) is not limited, but is typically a straight-chain structure, a partially branched straight-chain structure, a branched-chain structure, a cyclic structure, or a three-dimensional reticular structure. Component (C₂) may be one type of organopolysiloxane having these molecular structures or may be a mixture of two or more types of organopolysiloxanes having these molecular structures.

Examples of such component (C₂) include methylhydrogenpolysiloxanes capped at both molecular chain terminals with trimethylsiloxy groups, copolymers of dimethylsiloxane and methylhydrogensiloxane capped at both molecular chain terminals with trimethylsiloxy groups, dimethylpolysiloxanes capped at both molecular chain terminals with dimethylhydrogensiloxy groups, copolymers of dimethylsiloxane and methylhydrogensiloxane capped at both molecular chain terminals with dimethylhydrogensiloxy groups, copolymers consisting of (CH₃)₂HSiO_{1/2} units and SiO_{4/2} units, copolymers consisting of (CH₃)₂HSiO_{1/2} units, (CH₃)₃HSiO_{1/2} units, and SiO_{4/2} units, and mixtures of two or more types thereof.

Component (C₃) is a disilylbenzene represented by the following general formula:

HR¹₂Si—C₆H₄—SiR¹₂H

wherein each R¹ is as described above.

Examples of such component (C₃) include the following disilylbenzenes:

H(CH₃)₂Si—C₆H₄—Si(CH₃)₂H; and

H(CH₃)(C₂H₅)Si—C₆H₄—Si(CH₃)(C₂H₅)H.

The organosilicon compound for component (C) may be a mixture of components (C₁) and (C₂). However, component (C) typically has a viscosity at 25° C. of not more than 1,000 mPa·s, alternatively not more than 500 mPa·s, or alternatively not more than 100 mPa·s. Note that in the present specification, viscosity is the value measured using a type B viscometer according to ASTM D 1084 at 23±2° C.

Component (C) is used in an amount of from 0 to 30 mass %, alternatively in an amount of from 0 to 20 mass %, or alternatively in an amount of from 0 to 10 mass %, each based on a total mass of components (A) to (C). This is because, if the amount is equal to or above the lower limit of the ranges described above, the composition has good handleability, whereas if the amount is equal to or below the upper limit of the ranges described above, the composition has good transparency. The organosilicon compound for component (C) may be a mixture of components (C₁) to (C₃). While the amounts of components (C₁) to (C₃) are not limited, the amount of component (C) should be an amount that a molar ratio of all silicon atom-bonded hydrogen atoms relative to all silicon atom-bonded alkenyl groups in components (A) to (D) is 0.5 or more and less than 1.0.

A molar ratio (“SiH/Vi ratio”) of all silicon atom-bonded hydrogen atoms relative to all silicon atom-bonded alkenyl groups in components (A) to (D) is 0.5 or more and less than 1.0, alternatively in a range of from 0.5 to 0.95, or alternatively in a range of from 0.6 to 0.9. This is because, if the molar ration is equal to or above the lower limit of the ranges described above, the composition can be fully cured, and a cured product obtained by curing the present composition will have appropriate hardness and a less- or non-sticky surface, whereas if the molar ratio is equal to or below the upper limit of the ranges described above, the cured product has good hotmelt property.

Component (D) is an organosilicon compound having at least one silicon atom-bonded acryloxyalkyl group or silicon atom-bonded methacryloxyalkyl group, and at least one silicon atom-bonded hydrogen atom in a molecule, which is added to the composition described herein, e.g., for the purpose of providing full cross-linking reaction of the cured product obtained by a hydrosilylation reaction, to conform it on a substrate by an active energy ray, etc.

The acryloxyalkyl group or methacryloxyalkyl group in component (D) is not limited, but it is typically an acryloxyalkyl group or a methacryloxyalkyl group represented by the following general formula:

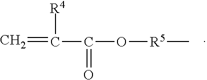

In the formula, R⁴ is a methyl group or a hydrogen atom.

In the formula, R⁵ is an alkylene group having 2 to 6 carbon atoms. Examples of the alkylene groups include ethylene groups, propylene, methylethylene groups, butylene groups, pentylene groups, and hexylene groups. Among these, propylene groups are preferable.

Silicon atom-bonded organic groups other than the acryloxyalkyl group and methacryloxyalkyl group in component (D) are not limited, but they are exemplified by alkyl groups with 1 to 12 carbon atoms such as methyl groups, ethyl groups, propyl groups, isopropyl groups, butyl groups, isobutyl groups, tert-butyl groups, pentyl groups, neopentyl groups, hexyl groups, cyclohexyl groups, heptyl groups, octyl groups, nonyl groups, decyl groups, undecyl groups and dodecyl groups; aryl groups with 6 to 12 carbon atoms such as phenyl groups, tolyl groups, xylyl groups and naphthyl groups; and aralkyl groups with 7 to 12 carbon atoms such as benzyl groups and phenethyl groups. Among these, methyl groups are preferable.

A molecular structure of component (D) is not limited, but is typically a straight-chain structure, a partially branched straight-chain structure, a branched-chain structure, a cyclic structure, or a three-dimensional reticular structure. Component (D) may be one type of organosilicon compounds having these molecular structures or may be a mixture of two or more types of organosilicon compounds having these molecular structures.

Examples of component (D) include organosilicon compounds represented by the following formulas:

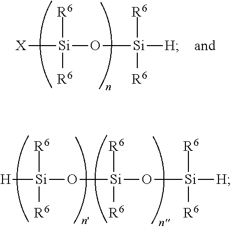

In the formulas, each R⁶ is independently an alkyl group or an aryl group, and examples thereof include the same groups as those described above.

In the formulas, each X is the acryloxyalkyl group or methacryloxyalkyl group, and examples thereof include the same groups those described above.

In the formulas, subscript n is an integer of 1 to 10, subscript n′ is an integer of 1 to 10, and subscript n″ is an integer of 0 to 10.

Examples of component (D) include organosilicon compounds represented by the following formulas:

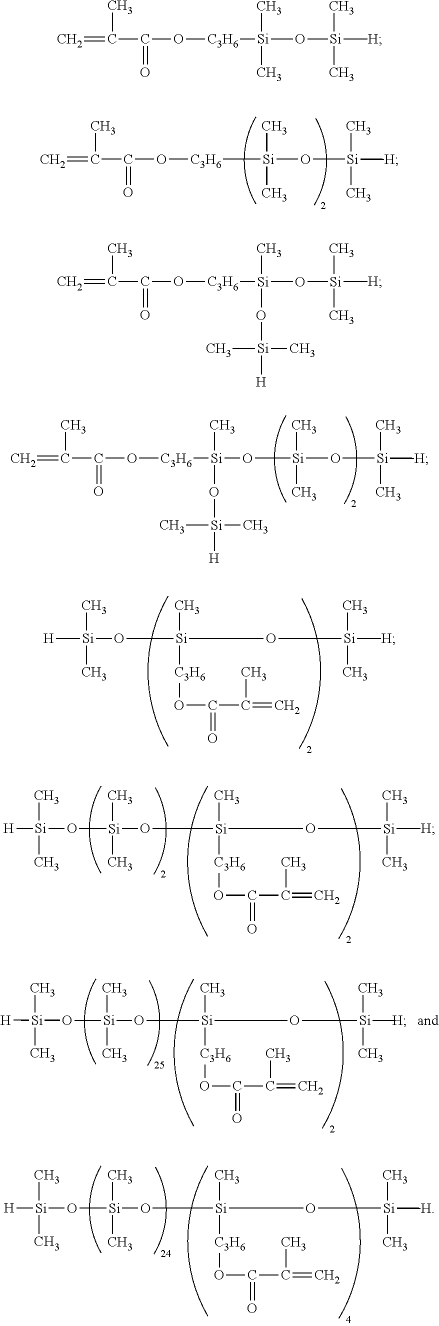

Methods of preparing component (D) is well known in the art, as exemplified in U.S. Pat. Nos. 4,554,339; 5,256,754; 5,334,796; and 9,018,332; and U.S. Patent Application Publication Nos. 2021/0122769 and 2014/0203323.

Component (D) is used in an amount of from 2 to 20 parts by mass, alternatively in an amount of from 4 to 20 parts by mass, each relative to 100 parts by mass of a total mass of components (A) to (C). This is because, if the amount is equal to or above the lower limit of the ranges described above, the composition has good curability by active energy ray, whereas if the amount is equal to or below the upper limit of the ranges described above, the composition has good stability.

As the acryloxyalkyl group or methacryloxyalkyl group content (hereinafter, referred to as a “(meth)acryl content”) is varied depending on molecular structure of Component (D), it is recommended to contain (meth)acryl contents in an amount of 4 mmol/100 g or more, alternatively in an amount of 8 mmol/100 g or more, or alternatively in an amount of 10 mmol/100 g or more, relative to a total mass of components (A) to (E), and optionally components (A) to (F) or components (A) to (G) (i.e., in embodiments where component (F) and/or component (G) are utilized along with components (A) to (E)). This is because, if the amount is equal to or above the lower limit of the ranges described above, the composition has good curability by active energy ray, as well as high-temperature stability. While its upper limit is not restricted because more (meth)acryl content is preferable to have better UV curability. However, it is typically 60 mmol/100 g or less.

Component (E) is a hydrosilylation reaction catalyst used to facilitate curing of the present composition. Hydrosilylation reaction catalysts for component (E) are well known in the art and commercially available. Suitable hydrosilylation reaction catalysts include, without limitation, a platinum group metal which includes platinum, rhodium, ruthenium, palladium, osmium, or iridium metal or an organometallic compound thereof and a combination of any two or more thereof. Component (E) is typically a platinum-based catalyst so that the curing of the present composition can be dramatically accelerated. Examples of the platinum-based catalyst include a platinum fine powder, chloroplatinic acid, an alcohol solution of chloroplatinic acid, a platinum-alkenylsiloxane complex, a platinum-olefin complex and a platinum-carbonyl complex, with a platinum-alkenylsiloxane complex being most typical.

In various embodiments, component (E) is a hydrosilylation reaction catalyst that includes complexes of platinum with low molecular weight organopolysiloxanes that include 1,3-divinyl-1,1,3,3-tetramethyldisiloxane complexes with platinum. These complexes may be microencapsulated in a resin matrix. In specific embodiments, the catalyst includes 1,3-divinyl-1,1,3,3-tetramethyldisiloxane complex with platinum.

Examples of suitable hydrosilylation reaction catalysts for component (E) are described in, for example, U.S. Pat. Nos. 3,159,601; 3,220,972; 3,296,291; 3,419,593; 3,516,946; 3,814,730; 3,989,668; 4,784,879; 5,036,117; and 5,175,325 and in EP 0 347 895 B. Microencapsulated hydrosilylation reaction catalysts and methods of preparing them are exemplified in U.S. Pat. Nos. 4,766,176 and 5,017,654.

An amount of component (E) in the present composition is an effective quantity for facilitating curing of the present composition. Specifically, in order to satisfactorily cure the present composition, the content of component (E) is typically a quantity whereby the content of catalytic metal in component (E) relative to the present composition is from about 0.01 to about 500 ppm, alternatively from about 0.01 to about 100 ppm, alternatively from about 0.01 to about 50 ppm, alternatively from about 0.1 to about 10 ppm, in terms of mass units.

In various embodiments, the active energy ray curable silicone composition comprises (F) a hydrosilylation reaction inhibitor in order to adjust the cure rate of the curable silicone composition. In certain embodiments, component (F) includes, without limitation, an alkyne alcohol such as 2-methyl-3-butyn-2-ol, 3,5-dimethyl-1-hexyn-3-ol, 2-phenyl-3-butyn-2-ol, or 1-ethynyl-cyclohexan-1-ol; an ene-yne compound such as 3-methyl-3-penten-1-yne or 3,5-dimethyl-3-hexen-1-yne; or 1,3,5,7-tetramethyl-1,3,5,7-tetravinylcyclotetrasiloxane, 1,3,5,7-tetramethyl-1,3,5,7-tetrahexenylcyclotetrasiloxane, tris[(1,1-dimethyl-2-propynyl)oxy]methylsilane, diallyl maleate or a benzotriazole may be incorporated as an optional component in the present composition.

An amount of component (F) in the present composition is not particularly limited, but if included is typically in an amount of from about 1 to about 10,000 ppm, alternatively an amount of from about 10 to about 5,000 ppm in this component in terms of mass units with respect to the present composition. This is because when the amount of component (F) is greater than or equal to the lower limit of the aforementioned range, storage stability of the composition is good, whereas when the amount of component (F) is less than or equal to the upper limit of the aforementioned range, curability of the composition at low temperatures is good.

In various embodiments, the active energy ray curable silicone composition comprises (G) a photoradical initiator to accelerate curing of the composition by an active energy ray. Examples of the photoradical initiators include acetophenone, propiophenone, benzophenone, 2-hydroxy-2-methylpropiophenone, 2,2-dimethoxy-1,2-diphenylethan-1-one, 1-hydroxycyclohexylphenylketone, 1-[4-(2-hydroxyethoxy)-phenyl]-2-hydroxy-2-methyl-1-propan-1-one, 2-hydroxy-1-{4-[4-(2-hydroxy-2-methyl-propionyl)-benzyl]phenyl}-2-methyl-propan-1-one, 2-methyl-1-(4-methylthiophenyl)-2-morpholinopropan-1-one, 2-benzyl-2-dimethylamino-(4-morpholinophenyl)-butanone-1, 2-(dimethylamino)-2-[(4-methylphenyl)methyl]-1-[4-(4-morpholinyl)phenyl]-1-butanone, 2,4,6-trimethylbenzoyl-diphenyl-phosphine oxide, bis(2,4,6-trimethylbenzoyl)-phenylphosphine oxide, 1,2-octanedione, 1-[4-(phenylthio)-2-(O-benzoyloxime)]ethanone, 1-[9-ethyl-6-(2-methylbenzoyl)-9H-carbazol-3-yl]-1-(0-acetyloxime), ethyl-4-dimethylaminobenzoate, 2-ethylhexyl-4-dimethylaminobenzoate, bis(2,6-dimethoxybenzoyl)-2,4,4-trimethyl-pentylphosphine oxide, benzoyl peroxide, cumene peroxide, and mixtures of two or more types of these.

An amount of component (G) in the present composition is an effective quantity for curing irradiating the present composition with an active energy ray, and is preferably in a range of from 0.1 to 15 parts by mass, alternatively in a range of from 0.1 to 10 parts by mass relative to 100 parts by mass of a total amount of components (A) to (C). This is because the obtained composition can be cured sufficiently when the content of component (G) is greater than or equal to the lower limit of the range described above, and meanwhile, heat resistance and light resistance of the resulting cured product is enhanced when the content is less than or equal to the upper limit of the range described above.

In various embodiments, the active energy ray curable silicone composition comprises a free radical scavenger (scavenger) that may be optionally used to control or inhibit a radical reaction of the active energy ray curable silicone composition. Because the active energy ray curable silicone composition comprises component (D), a viable free radical scavenger may be present to prevent premature reaction, for example, in storage and during use of the active energy ray reactive hot-melt film prepared using the present composition. Scavengers comprising phenolic compounds are one class of such materials that may be used in the invention, including, for example, 4-methoxyphenol (MEHQ, methyl ether of hydroquinone), hydroquinone, 2-methylhydroquinone, 2-t-butylhydroquinone, t-butyl catechol, butylated hydroxy toluene, and butylated hydroxy anisole, and combinations of two or more thereof.

Other scavengers that may be used include phenothiazine and anaerobic inhibitors, such as the NPAL type inhibitors (tris-(N-nitroso-N-phenylhydroxylamine) aluminum salt) from Albemarle Corporation, Baton Rouge, La. Alternatively, the free radical scavenger may be selected from the group consisting of a phenolic compound, phenothiazine and an anaerobic inhibitor. Free radical scavengers are known, for example, in U.S. Pat. No. 9,475,968, and are commercially available.

An amount of scavenger in the active energy ray curable silicone composition will depend on various factors including the type and amount of component (D), however the scavenger may be present in an amount of from 1 to 5,000 ppm by mass, alternatively in an amount of from 10 to 1,000 ppm by mass, or alternatively in an amount of from 50 to 500 ppm by mass, each relative to 100 mass of the present composition.

A viscosity at 25° C. of the present composition is not limited, but it is typically in a range from 100 to 100,000 mPa·s.

Next, the pre-cured and cured product of the present invention will be explained in detail.

A pre-cured product of the present invention is obtained by hydrosilylation reacting the above-mentioned curable silicone composition. The term “pre-cured” denotes the state where there is a crosslinked, but not fully crosslinked network (the state having middle physical properties between un-cured products and fully cured products). The pre-cured product may have a less- or non-sticky surface. In particular, a storage modulus G′ of the cured product at 20° C. is not limited, but it is typically within a range of 0.05 to 15 MPa, alternatively within a range of 0.07 to 10 MPa, or alternatively within a range of 0.1 to 5 MPa at the condition of frequency=1 Hz, Strain=1%. A melt viscosity at 100° C. of the pre-cured product is not limited, but it is typically in a range from 1 to 5000 Pa·s.

Then, a cured product of the present invention is obtained by irradiating the pre-cured product described above with an active energy ray. Examples of the active energy ray used to cure the pre-cured product include ultraviolet light and visible light; however, the light with a wavelength in a range of 250 to 500 nm is preferred. This is because excellent curability is achieved, and the cured product is not decomposed by the active energy ray.

The cured product is typically optically transparent. This is because when the cured product is preferably used for an optical device or an image display, optical transparency is desired for high performance. The form of the cured product is not limited and may be in a sheet, film, lens, or block form. The cured product may be combined with various substrates. The cured product is typically laminated between same or different substrates, and especially, between same or different substrates in an optical device.

The state of the cured product is not limited, but it is preferably an elastomer. In particular, a storage modulus G′ of the cured product at 20° C. is not limited, but it is typically within a range of 0.05 to 20 MPa, alternatively within a range of 0.07 to 15 MPa, or alternatively within a range of 0.1 to 10 MPa at the condition of frequency=1 Hz, Strain=1%. This is because when the cure product is within the range described above, good cohesive strength against deformation and good flexibility against material fracture are obtained. In general, the cured product no longer has a hot-melt property.

A method of producing the cured product is not limited, but it is exemplified by a method comprising the following steps:
1) curing the curable silicone composition of the present invention to form a pre-cured product by hydrosilylation reaction;
2) placing the pre-cured product on a target substrate, and applying heat to and/or pressure onto the pre-cured product placed on a target substrate; and
3) exposing the pre-cured product to an active energy ray.

In step 1), the curable silicone composition is heated to form a desired shape of a pre-cured product by hydrosilylation reaction. Typically, the cure rate can be controlled by the amount and the ratio of component (E) and (F), and the temperature can be room temperature to 180° C. preferably, 80° C. to 150° C. A shape of the pre-cured product is not limited, but it is preferably a sheet, film, lens, or block form. The pre-cured product contains a free (meth)acryl group, which can be analyzed by Fourier Transform-Infrared (FT-IR) spectroscopy as illustrated in ‘UV coatings: basics, recent developments and new applications’, at page 33 (Elsevier; 2006 Dec. 21) and Schwalm; Polymer Chemistry. 2013; 4(8):2449-56 to Espeel.

In step 2), the pre-cured product is deformed or melted to conform it to a target substrate by heating and/or pressure as the pre-cured product has thermoplastic and hotmelt property. Typically, the temperature can be up to 150° C., preferably, up to 100° C. When pressure is applied to the pre-cured product to conform it to the target substrate, the applied pressure can be generally 0.05 MPa or more, alternatively 0.1 MPa or more, and 2 MPa or less, alternatively 1 MPa or less. To remove voids completely (to obtain bubble free laminates), vacuum may be applied during lamination upon complexity of three-dimensional feature of the target surface, generally 25 torr or less, alternatively 5 torr or less.

In step 3), the pre-cured product is exposed to an active energy ray (e.g., by means of a UV LED lamp) to form a cured product without changing the shape. The ultraviolet-curing is conducted by ultraviolet irradiation, however, the ultraviolet source generally does not matter if the lamp for irradiating emits rays near ultraviolet. Typically, to control cure rate precisely, a UV LED lamp is generally used. Typical wavelengths of UV LED lamps are 365, 385, 395 and 405 nm. Preferably, 365 nm and 395 nm are generally used. Irradiation dose is preferably in a range of from 0.1 to 200 J/cm², or optionally in a range of from 1 to 100 J/cm². The irradiation of ultraviolet rays is usually in the air. Optionally, to prevent surface oxygen inhibition, the pre-cured product may be irradiated with ultraviolet rays in a laminated state with a transparent or translucent substrate, for example, polyethylene terephthalate film and glass. Alternatively, the pre-cured product may be irradiated with ultraviolet rays in an environment of a gas which does not cause curing inhibition such as nitrogen and carbon dioxide.

The pre-cured product is useful as laminates on various target substrates having flat surface as well as uneven surface in an electronic device, an optical device or an image display, and to obtain the laminated cured product by ultraviolet irradiation. The electronic device is for example, a semiconductor device. Examples of the semiconductor device includes semiconductor package such as a ball grid array (BGA) package, a pin grid array (PGA) package, and a land grid array (LGA). The optical device is, for example, an optical semiconductor device. Examples of the optical semiconductor device include a light emitting diode (LED), a photocoupler, and a charge-coupled device (CCD). Moreover, a light emitting diode (LED) element and a solid-state image sensor are illustrated as an optical semiconductor element. In particular, even in the case of collectively sealing a so-called micro LED (mini LED) having a structure in which a large number of small LED elements are disposed on a substrate, the curable silicone composition of the present invention can be suitably used. Furthermore, since the curable silicone composition of the present invention is excellent in heat resistance and moisture resistance, it is hard to cause a decrease in transparency and hardly causes turbidity. Therefore, there is an advantage that the light extraction efficiency of the optical semiconductor device including the micro LED can be maintained well.

### EXAMPLES

The active energy ray curable silicone composition and the cured product of the present invention will be described in detail hereinafter using Examples and Comparative Examples. However, the present invention is not limited by the description of the below listed Examples.

### [Gel Permeation Chromatography (GPC)]

GPC data for component (a1) was collected using a Waters 2695 Separation Module from Waters Corporation with Waters 2414 Refractive index detector (RID). Three (7.8 by 300 mm) Styragel HR columns (with a molecular weight separation range of 100 to 4,000,000) and a Styragel protection column with toluene (4.6 by 30 mm) are used as the columns. The sample was prepared as a 0.5 mass % solution in toluene and filtered through a 0.45 micron PTFE syringe filter. Using a flow rate of one milliliter per minute, the temperature of the detector and the column are 45° C., the injection volume is 100 microliters, and the running time is 60 minutes. Number average molecular weights (Mn) was calculated relative to linear polystyrene standards covering the molecular weight range of 580 to 2,610,000.

### [Viscosity]

A viscosity at 25° C. of each organosiloxane oligomers was measured by means of DV1 VISCOMETER (Brookfield) using the spindle #CPA-40Z Active energy ray curable silicone compositions was measured by means of HADV III VISCOMETER (Brookfield) using the spindle #CP-25. The viscosity was measured for 2 minutes and torque was controlled at the range of 20-80%. The latest data was collected after measurement was completed.

### [Degree of Stickiness]

Samples of the active energy ray curable silicone compositions were cured, and a degree of stickiness was evaluated as follows: Each sample prepared as described above was poured into an aluminum dish and was cured by heating the sample for 30 min at 120° C., and cooled to room temperature. The sample is considered “Non-sticky” if it does not stick to the fingers. The sample is considered “Sticky” if it sticks to the fingers.

### [Melt Viscosity]

The melting behavior of the resulting silicone hotmelt which is obtained by curing the active energy ray curable silicone composition for 30 minutes at 120° C. could be observed by exposing the solid sample to 100° C. “Melted” means a shape of samples is collapsed and spread out on the substrate. “Not melted” means a shape of sample is maintained. If the sample is not melted at the elevated temperature, melt viscosity could not be measured because it is fully crosslinked. To measure melt viscosity, the hotmelt sample were prepared in the same manner described above, and the sample was mounted onto a parallel-plate geometry (25 mm) of a rheometer (ARES-G2, TA Instruments). Then, the melt viscosity was collected at a fixed shear rate of 1 1/s and a gap of 300 μm at 100° C.

### [Storage Modulus and Loss Modulus]

Samples of the active energy ray curable silicone compositions were cured and shear modulus of the resulting silicone hotmelt were evaluated as follows: Each sample prepared as described above was poured into a mold (thickness=1 mm) and sandwiched between releasable films. The assembled samples were cured by heating the sample for 30 min at 120° C. After cooled and the releasable film was removed, the sample was mounted onto a parallel-plate geometry (25 mm) of a rheometer (ARES-G2, TA Instruments). Then, the dynamic storage modulus (G′) was collected at a fixed frequency of 1 Hz with a strain of 0.5%, a gap of 300 μm and a normal force of 0 N at 20° C. and 100° C.

For measurement of property after UV, the above assembled samples were cured by heating the sample for 30 min at 120° C. and followed by exposure to the UV light to promote photo radical crosslinking reaction. The conditions for UV irradiating were ultraviolet light at a UV illuminance of 10 J/cm² was irradiated from the top surface of the film with a 365 nm LED lamp (FireJet™ FJ100).

### Examples 1-8 and Comparative Examples 1-7

The following components were mixed to uniformity in the quantity proportions shown in Table 1 to produce active energy ray curable silicone compositions. When component (A) was a solid at 25° C., it was added to other components by using a solvent such as toluene and xylene due to high viscosity. Then, to prepare a solventless composition, the solvent was evaporated and replaced with other components to facilitate mixing. For example, firstly, component (B) was added to a solution of component (A) dissolved in a solvent. Then, the solvent was removed under reduced pressure by heating with nitrogen bubbling. After cooling to room temperature, component (C) was added. The mixture was mixed at room temperature. Additionally, other components were added to the mixture and mixed at room temperature. The resulting compositions and cured products were evaluated as mentioned above. These results are given in Table 1. The “SiH/Vi ratio” in each of Table 1 indicates a molar ratio of all silicon atom-bonded hydrogen atoms relative to all silicon atom-bonded vinyl groups in components (A) to (D). Furthermore, the “(Meth)acryl content” in each of Table 1 indicates a content of methacryloxypropyl group relative to a total mass of components (A) to (G).

The following organopolysiloxane resin was used as component (A).
(a1): an organopolysiloxane resin represented by the following average unit formula:

[(CH₃)₃SiO_{1/2}]_{0.40}[(CH₂═CH)(CH₃)₂SiO_{1/2}]_{0.04}(SiO_{4/2})_{0.56}
having a vinyl group content of about 1.9 mass % and a number average molecular weight (Mn) of about 5,000, and being a solid at 25° C.

The following organosiloxane oligomers were used as component (B).
(b1): an organosiloxane oligomer represented by the following formula:

(CH₂═CH)(CH₃)₂SiO(C₆H₅)₂SiOSi(CH₃)₂(CH═CH₂)
and having a viscosity of 8.7 mPa·s and a vinyl group content of about 14.06 mass %
(b2): an organosiloxane oligomer represented by the following formula:

H(CH₃)₂SiO(C₆H₅)₂SiOSi(CH₃)₂H
and having a viscosity of 4.4 mPa·s and a silicon atom-bonded hydrogen atom content of about 0.61 mass %

The following organopolysiloxanes or disilylbenzene were used as component (C).
(c1): an organopolysiloxane represented by the following formula:

(CH₂═CH)(CH₃)₂SiO[(CH₃)₂SiO]₇Si(CH₃)₂(CH═CH₂)
and having a viscosity of 7 mPa·s and a vinyl group content of about 7.49 mass %
(c2): 1,4-bis(dimethysilyl)benzene
(c3): an organopolysiloxane represented by the following formula:

H(CH₃)₂SiO[(CH₃)₂SiO]₁₆Si(CH₃)₂H
and having a viscosity of 15 mPa·s and a silicon atom-bonded hydrogen atom content of about 0.15 mass %

The following organosilicon compounds were used as component (D).
(d1): an organotrisiloxane represented by the following formula:

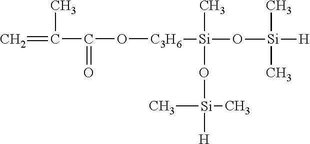

and having a methacryl content of 313.0 mmol/100 g and a silicon atom-bonded hydrogen atom content of about 0.63 mass %
(d2): an organodisiloxane represented by the following formula:

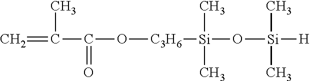

and having a methacryl content of 385.0 mmol/100 g and a silicon atom-bonded hydrogen atom content of about 0.38 mass %
(d3): an organopolysiloxane represented by the following formula:

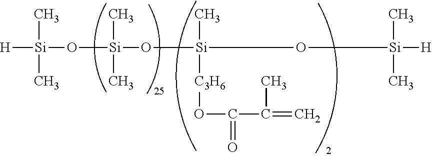

and having a methacryl content of 81.6 mmol/100 g and a silicon atom-bonded hydrogen atom content of about 0.086 mass %
(d4): an organopolysiloxane represented by the following formula:

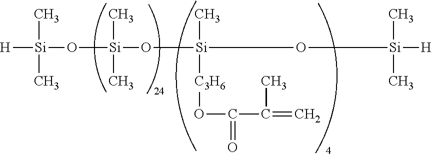

and having a methacryl content of 151.2 mmol/100 g and a silicon atom-bonded hydrogen atom content of about 0.076 mass %

The following hydrosilylation reaction catalyst was used as component (E).
(e1): a platinum complex with 1,3-divinyl-1,1,3,3-tetramethyldisiloxane in a 1,3-divinyl-1,1,3,3-tetramethyldisiloxane solution (platinum content=4 mass %)

The following hydrosilylation reaction inhibitor was used as component (F).
(f1): 1-ethynyl-cyclohexan-1-ol

The following photo-radical initiators were used as component (G).
(g1): 2-benzyl-2-dimethylamino-1-(4-morpholinophenyl)-butanone-1
(g2): 1-hydroxycyclohexyl phenyl ketone

TABLE 1

| | | | Examples | | | |
|---|---|---|---|---|---|---|
| | | | 1 | 2 | 3 | 4 |
| Formulation of Active | (A) | (a1) | 68.4 | 71.4 | 70.7 | 61.5 |
| Energy Ray Curable | (B) | (b1) | 16.9 | 17.6 | 17.4 | 24.6 |
| Silicone Composition | | (b2) | 11.9 | 8.8 | 8.7 | 7.6 |
| (parts by mass) | (C) | (c1) | 2.8 | 2.2 | 2.1 | 2.1 |
| | | (c2) | 0 | 0 | 1.1 | 4.2 |
| | (D) | (d1) | 5.3 | 11.1 | 5.3 | 5.3 |
| | | (d2) | 0 | 0 | 0 | 0 |
| | (E) | (e1) | 0.014 | 0.014 | 0.014 | 0.014 |
| | (F) | (f1) | 0.005 | 0.006 | 0.005 | 0.005 |
| | (G) | (g1) | 0.3 | 0.3 | 0.3 | 0.3 |
| Content of component (B) (mass %) | | | 28.8 | 26.4 | 26.1 | 32.2 |
| Content of component (C) (mass %) | | | 2.8 | 2.2 | 3.2 | 6.3 |
| SiH/Vi ratio | | | 0.73 | 0.83 | 0.66 | 0.69 |
| (Meth)acryl content (mmol/100 g) | | | 15.6 | 31.2 | 15.6 | 15.6 |
| Viscosity at 25° C. (mPa · s) | | | 6,499 | 3,582 | 11,113 | 391 |
| After | Degree of stickiness | | Non- | Non- | Non- | Non- |
| Heat | | | sticky | sticky | sticky | sticky |
| Cure | Properties | Storage | 2.87E+05 | 2.69E+05 | 6.57E+05 | 4.14E+05 |
| | at 20° C. | Modulus (Pa) | | | | |
| | | Loss | 3.84E+05 | 3.83E+05 | 7.89E+05 | 6.16E+05 |
| | | Modulus (Pa) | | | | |
| | | tan δ | 1.3 | 1.4 | 1.2 | 1.5 |
| | Properties | Storage | 192 | 1599 | 173 | 51 |
| | at 100° C. | Modulus (Pa) | | | | |
| | | Loss | 1304 | 3657 | 1699 | 678 |
| | | Modulus (Pa) | | | | |
| | | tan δ | 6.8 | 2.3 | 9.3 | 13.3 |
| | Melting Behavior | | Melted | Melted | Melted | Melted |
| | at 100° C. | | | | | |
| | Melt Viscosity | | 180 | 1294 | 206 | 97 |
| | at 100° C. (Pa · s) | | | | | |
| After | Properties | Storage | 6.05E+05 | 1.30E+05 | 1.68E+05 | 9.32E+04 |
| Heat | at 20° C. | Modulus (Pa) | | | | |
| Cure | | Loss | 3.90E+05 | 2.31E+04 | 8.21E+04 | 3.84E+04 |
| followed | | Modulus (Pa) | | | | |
| by UV | | tan δ | 0.7 | 0.2 | 0.5 | 0.4 |
| | Properties | Storage | 6.26E+04 | 1.01E+05 | 2.18E+04 | 2.80E+04 |
| | at 100° C. | Modulus (Pa) | | | | |
| | | Loss | 2.50E+04 | 2.63E+04 | 1.23E+04 | 2.13E+04 |
| | | Modulus (Pa) | | | | |
| | | tan δ | 0.4 | 0.3 | 0.6 | 0.8 |

| Melting Behavior at 100° C. | Not | Not | Not | Not |
|---|---|---|---|---|
| | Melted | Melted | Melted | Melted |
| Transmittance at 550 nm (%) | 98.42 | 99.37 | 99.37 | 95.68 |

| | | | Examples | | | |
|---|---|---|---|---|---|---|
| | | | 5 | 6 | 7 | 8 |
| Formulation of Active | (A) | (a1) | 67.9 | 69.8 | 73.0 | 73.0 |
| Energy Ray Curable | (B) | (b1) | 16.7 | 17.2 | 13.4 | 13.2 |
| Silicone Composition | | (b2) | 15.3 | 13.0 | 13.6 | 13.8 |
| (parts by mass) | (C) | (c1) | 0 | 0 | 0 | 0 |
| | | (c2) | 0 | 0 | 0 | 0 |
| | (D) | (d1) | 0 | 0 | 0 | 0 |
| | | (d2) | 5.3 | 9.9 | 0 | 0 |
| | | (d3) | 0 | 0 | 16.3 | 0 |
| | | (d4) | 0 | 0 | 0 | 16.3 |
| | (E) | (e1) | 0.014 | 0.014 | 0.030 | 0.030 |
| | (F) | (f1) | 0.005 | 0.005 | 0.006 | 0.006 |
| | (G) | (g1) | 0.3 | 0.3 | 0 | 0 |
| | | (g2) | 0 | 0 | 1.2 | 1.2 |
| Content of component (B) (mass %) | | | 32.0 | 30.2 | 27.0 | 27.0 |
| Content of component (C) (mass %) | | | 0 | 0 | 0.0 | 0.0 |
| SiH/Vi ratio | | | 0.84 | 0.85 | 0.80 | 0.81 |
| (Meth)acryl content (mmol/100 g) | | | 19.19 | 34.54 | 11.30 | 20.94 |
| Viscosity at 25° C. (mPa · s) | | | 3,817 | 1,773 | 19,077 | 28,091 |
| After | Degree of stickiness | | Non- | Non- | Non- | Non- |
| Heat | | | sticky | sticky | sticky | sticky |
| Cure | Properties | Storage | 9.40E+05 | 1.92E+05 | 3.74E+05 | 2.54E+05 |
| | at 20° C. | Modulus (Pa) | | | | |
| | | Loss | 8.19E+05 | 3.87E+05 | 5.05E+05 | 4.52E+05 |
| | | Modulus (Pa) | | | | |
| | | tan δ | 0.9 | 2.0 | 1.4 | 1.8 |
| | Properties | Storage | 558 | 11 | 522 | 211 |
| | at 100° C. | Modulus (Pa) | | | | |
| | | Loss | 3806 | 463 | 2377 | 1752 |
| | | Modulus (Pa) | | | | |
| | | tan δ | 6.8 | 41.4 | 4.6 | 8.3 |
| | Melting Behavior | | Melted | Melted | Melted | Melted |
| | at 100° C. | | | | | |
| | Melt Viscosity | | 627 | 70 | 504 | 291 |
| | at 100° C. (Pa·· s) | | | | | |
| After | Properties | Storage | 9.66E+05 | 4.28E+05 | 2.80E+06 | 7.83E+06 |
| Heat | at 20° C. | Modulus (Pa) | | | | |
| Cure | | Loss | 8.08E+05 | 3.37E+05 | 1.61E+06 | 3.08E+06 |
| followed | | Modulus (Pa) | | | | |
| by UV | | tan δ | 0.8 | 0.8 | 0.6 | 0.4 |
| | Properties | Storage | 2.10E+04 | 1.54E+04 | 8.23E+04 | 2.74E+05 |
| | at 100° C. | Modulus (Pa) | | | | |
| | | Loss | 1.70E+04 | 1.16E+04 | 4.85E+04 | 1.84E+05 |
| | | Modulus (Pa) | | | | |
| | | tan δ | 0.8 | 0.8 | 0.6 | 0.7 |

| | | | | |
|---|---|---|---|---|
| Melting Behavior | Not | Not | Not | Not |
| at 100° C. | Melted | Melted | Melted | Melted |
| Transmittance | 98.98 | 99.37 | 99.89 | 99.84 |
| at 550 nm (%) | | | | |

Comparative Examples

| | | | 1 | 2 | 3 | 4 |
|---|---|---|---|---|---|---|
| Formulation of Active | (A) | (a1) | 51.9 | 63.8 | 63.8 | 65.6 |
| Energy Ray Curable | (B) | (b1) | 31.7 | 17.8 | 15.7 | 16.2 |
| Silicone Composition | | (b2) | 16.4 | 7.9 | 20.5 | 14.2 |
| (parts by mass) | (C) | (c1) | 0 | 10.5 | 0 | 4.0 |
| | | (c2) | 0 | 0 | 0 | 0 |
| | (D) | (d1) | 5.3 | 5.3 | 5.3 | 1.0 |
| | | (d2) | 0 | 0 | 0 | 0 |
| | (E) | (e1) | 0.014 | 0.014 | 0.014 | 0.013 |
| | (F) | (f1) | 0.005 | 0.005 | 0.005 | 0.005 |
| | (G) | (g1) | 0.3 | 0.3 | 0.3 | 0.3 |
| Content of component (B) (mass %) | | | 48.1 | 25.7 | 36.2 | 30.4 |
| Content of component (C) (mass %) | | | 0 | 10.5 | 0 | 4.0 |
| SiH/Vi ratio | | | 0.66 | 0.48 | 1.25 | 0.65 |
| (Meth)acryl content (mmol/100 g) | | | 15.6 | 15.6 | 15.6 | 3.1 |
| Viscosity at 25° C. (mPa · s) | | | 758 | 7,124 | 1,636 | 10,517 |
| After | Degree of Stickiness | | Sticky | Sticky | Non- | Non- |
| Heat | | | | | sticky | sticky |
| Cure | Properties | Storage | 1.32E+04 | 1.38E+04 | 4.84E+05 | 1.99E+05 |
| | at 20° C. | Modulus (Pa) | | | | |
| | | Loss | 2.49E+04 | 6.71E+04 | 2.08E+05 | 3.27E+05 |
| | | Modulus (Pa) | | | | |
| | | tan δ | 1.9 | 4.9 | 0.4 | 1.6 |
| | Properties | Storage | 1.20E+02 | 5.79E+00 | 1.89E+05 | 4.42E+01 |
| | at 100° C. | Modulus (Pa) | | | | |
| | | Loss | 5.98E+02 | 1.32E+02 | 1.37E+05 | 6.78E+02 |
| | | Modulus (Pa) | | | | |
| | | tan δ | 5.0 | 22.7 | 0.1 | 15.4 |
| | Melting Behavior | | Melted | Melted | Not | Melted |
| | at 100° C. | | | | Melted | |
| | Melt Viscosity | | 58.37 | 20.78 | — | 96 |
| | at 100° C. (Pa· · s) | | | | | |
| After | Properties | Storage | — | — | — | 4.16E+04 |
| Heat | at 20° C. | Modulus (Pa) | | | | |
| Cure | | Loss | — | — | — | 8.88E+04 |
| followed | | Modulus (Pa) | | | | |
| by UV | | tan δ | — | — | — | 2.1 |
| | Properties | Storage | — | — | — | 3.56E+01 |
| | at 100° C. | Modulus (Pa) | | | | |
| | | Loss | — | — | — | 2.91E+02 |
| | | Modulus (Pa) | | | | |
| | | tan δ | — | — | — | 8.1 |

| | | | | |
|---|---|---|---|---|
| Melting Behavior | — | — | — | Melted |
| at 100° C. | | | | |

| | | | Comparative Examples | | |
|---|---|---|---|---|---|
| | | | 5 | 6 | 7 |
| Formulation of Active | (A) | (a1) | 65.6 | 66.7 | 66.0 |
| Energy Ray Curable | (B) | (b1) | 16.2 | 0 | 0 |
| Silicone Composition | | (b2) | 14.2 | 0 | 0 |
| (parts by mass) | (C) | (c1) | 4.0 | 11.1 | 25.0 |
| | | (c3) | 0 | 22.2 | 8.3 |
| | (D) | (d1) | 1.0 | 5.0 | 5.0 |
| | | (d2) | 0 | 0 | 0 |
| | (E) | (e1) | 0.013 | 0.013 | 0.013 |
| | (F) | (f1) | 0.005 | 0.005 | 0.005 |
| | (G) | (g1) | 0.3 | 0.3 | 0.3 |
| Content of component (B) (mass %) | | | 30.3 | 0 | 0 |
| Content of component (C) (mass %) | | | 4.0 | 33.3 | 33.3 |
| SiH/Vi ratio | | | 0.64 | 0.86 | 0.41 |
| (Meth)acryl content (mmol/100 g) | | | 3.8 | 15.8 | 15.8 |
| Viscosity at 25° C. (mPa · s) | | | 1,636 | 10,120 | 9,865 |
| | Degree of Stickiness | | Non- | Non- | Sticky |
| | | | sticky | sticky | |
| After | Properties | Storage | 1.06E+05 | 2.36E+05 | 1.13E+04 |
| Heat | at 20° C. | Modulus (Pa) | | | |
| Cure | | Loss | 2.19E+05 | 1.43E+05 | 7.52E+04 |
| | | Modulus (Pa) | | | |
| | | tan δ | 2.1 | 0.6 | 6.7 |
| | Properties | Storage | 1.48E+01 | 6.47E+04 | 2.10E+00 |
| | at 100° C. | Modulus (Pa) | | | |
| | | Loss | 3.57E+02 | 1.01E+04 | 5.00E+01 |
| | | Modulus (Pa) | | | |
| | | tan δ | 24.2 | 0.2 | 23.8 |
| | Melting Behavior | | Melted | Not | Melted |
| | at 100° C. | | | Melted | |
| | Melt Viscosity | | 56 | — | — |
| | at 100° C. (Pa·· s) | | | | |
| After | Properties | Storage | 2.20E+04 | — | — |
| Heat | at 20° C. | Modulus (Pa) | | | |
| Cure | | Loss | 6.60E+04 | — | — |
| followed | | Modulus (Pa) | | | |
| by UV | | tan δ | 2.922 | — | — |
| | Properties | Storage | 1.06E+01 | — | — |
| | at 100° C. | Modulus (Pa) | | | |
| | | Loss | 1.41E+02 | — | — |
| | | Modulus (Pa) | | | |
| | | tan δ | 13.23 | — | — |

| | | | |
|---|---|---|---|
| Melting Behavior | Melted | — | — |
| at 100° C. | | | |

Examples 1-8 are representative examples of active energy ray curable silicone compositions including components (A) to (G), which afford flowable liquid at the range of 300 to 30,000 mPa·s at 25° C. After heat cure (hydrosilylation reaction), the curable silicone compositions afford solid or semi-solid at room temperature, non-sticky surface having relatively high storage modulus (G′) more than 9×10⁴ Pa at 20° C., and significant storage modulus decreasing (melting) behavior at high temperature such as 100° C. When exposed to high temperature, the solid state of heat-cured silicone composition is transformed to flowable liquid having rotational viscosity at the range from 70 to 1,300 Pa·s (at 100° C.). UV irradiation after heat cure provides further crosslinking reaction by radical reaction of free methacryl group (from component (D)) initiated by photoradical initiator (G), and it is fully conformed. Accordingly, further crosslinking by UV promotes to increase storage modulus more than 1×10⁴ Pa at 100° C., and ultimately exhibits high temperature stability without deformation. In addition, it shows good transparency at visible range.

In contrast, Comparative Examples 1-7 demonstrate unfavorable property such as sticky surface and no hotmelt property to be used in an industrial field even although components (A) to (G) which are used in Examples 1-8 are all included. Comparative Examples 1-2 and 7 show that cured products had sticky surface, so it is failed to prepare high modulus hotmelt base (after heat cure). Comparative Examples 3 and 6 show that cured products had no hotmelt behavior (NOT melted) (after heat cure), so that it fails to prepare hotmelt base. When Comparative Example 1 and Example 2-4 are compared, Comparative Example 1 that includes the relatively lower amount of component (A) (51.9%) affords sticky surface having lower storage modulus less than 2×10⁴ Pa after heat cure. When Comparative Examples 2-3 and Examples 1-8 are compared, Comparative Example 2 (when SiH/Vi ratio is 0.48) affords sticky surface having relatively low storage modulus less than 2×10⁴ Pa after heat cure. Moreover, Comparative Example 3 (SiH/Vi=1.25) does not show melting behavior due to higher crosslinking density. Accordingly, without wishing to be bound by theory, it is thought that curable silicone composition affords a less- or non-sticky surface as well as melting property after heat cure when SiH/Vi Ratio is more than 0.48 and less than 1.00.

Comparative Examples 4 and 5 demonstrate that curable silicone composition having methacryl contents of 3.1 and 3.8 mmol/100 g in total composition shows melting behavior even after UV irradiation due to lack of further crosslinking by UV radical reaction. In Contrast, Examples 1-8 shows no melting behavior after fully cured (when methacryl contents is 4 mmol/100 g or more). Accordingly, methacryl content is thought to impart UV crosslinking reaction to have high temperature stability. Without wishing to be bound by theory, it is thought that curable silicone composition affords fully conformed network after heat cure followed by UV cure when the methacryl contents is 4 mmol/100 g or more in a total mass of components (A) to (G).

Comparative Examples 6 and 7 demonstrate curable silicone composition without component (B) affords no hotmelt behavior when SiH/Vi ratio is 0.86 and sticky surface (low storage modulus less than 2×10⁴ Pa at 20° C.) when SiH/Vi ratio is 0.41, respectively. Therefore, without component (B), it failed to obtain solventless curable composition exhibiting non-sticky surface with hotmelt property after heat cure.

### INDUSTRIAL APPLICABILITY

The active energy ray curable silicone composition of the present invention has an excellent handleability at a room temperature without using a solvent, cures by heat to form a less- or non-sticky pre-cured product at room temperature with an excellent melt viscosity by heating, and cures further by an active energy ray to form a cured product which no longer has a hot-melt property. Therefore, the active energy ray curable silicone composition is useful for sealants, adhesives, or coatings of an optical semiconductor element in electric/electronic apparatuses.

1. An active energy ray curable silicone composition comprising:
(A) an organopolysiloxane resin represented by the following average unit formula:
(R¹₃SiO_{1/2})ₐ(R²R¹₂SiO_{1/2})_{b}(SiO_{4/2})_{c}(HO_{1/2})_{d}
wherein each R¹ is independently an alkyl group; R² is an alkenyl group; and subscripts a, b, c and d are numbers satisfying the following conditions: a≥0, b>0, 0.3≤c≤0.7, 0≤d≤0.05, and a+b+c=1;
(B) an organosiloxane oligomer having a viscosity at 25° C. of not more than 1,000 mPa·s, and selected from the group consisting of (B₁) an organosiloxane oligomer having at least one silicon atom-bonded alkenyl group and at least one silicon atom-bonded aryl group in a molecule, (B₂) an organosiloxane oligomer having at least one silicon atom-bonded hydrogen atom and at least one silicon atom-bonded aryl group in a molecule, and a mixture of components (B₁) and (B₂);
(C) optionally, an organosilicon compound selected from the group consisting of (C₁) an organopolysiloxane having at least one alkenyl group and not having a silicon atom-bonded aryl group and SiO_{4/2} unit in a molecule, (C₂) an organopolysiloxane having at least one silicon atom-bonded hydrogen atom and not having a silicon atom-bonded aryl group in a molecule, (C₃) a disilylbenzene represented by the following general formula:
HR¹₂Si—C₆H₄—SiR¹₂H
wherein each R¹ is independently an alkyl group, and mixtures thereof;
(D) an organosilicon compound having at least one silicon atom-bonded acryloxyalkyl group or silicon atom-bonded methacryloxyalkyl group, and at least one silicon atom-bonded hydrogen atom in a molecule; and
(E) a catalytic amount of a hydrosilylation reaction catalyst;
wherein an amount of component (A) is in a range of from 50 to 80 mass %, an amount of component (B) is in a range of from 5 to 40 mass %, an amount of component (C) is in a range of from 0 to 30 mass %, each based on a total mass of components (A) to (C), and an amount of component (D) is in a range of from 2 to 20 parts by mass relative to 100 parts by mass of a total mass of components (A) to (C), with the proviso that a molar ratio of all silicon atom-bonded hydrogen atoms relative to all silicon atom-bonded alkenyl groups in components (A) to (D) is 0.5 or more and less than 1.0.

2. The active energy ray curable silicone composition according to claim 1, wherein component (B₁) is present and an organosiloxane oligomer represented by the following general formula:
R²R³₂SiO(R³₂SiO)ₘSiR³₂R²
wherein each R² is independently an alkenyl group; each R³ is independently an alkyl group or an aryl group, with the proviso that at least one R³ is an aryl group; and subscript m is an integer of 0 to 10.

3. The active energy ray curable silicone composition according to claim 2, wherein component (B₁) is at least one selected from organosiloxane oligomers represented by the following formulas:
(CH₂═CH)(CH₃)₂SiO(C₆H₅)₂SiOSi(CH₃)₂(CH═CH₂);
(CH₂═CH)(CH₃)₂SiO(C₆H₅)(CH₃)SiOSi(CH₃)₂(CH═CH₂); and
(CH₂═CH)(CH₃)(C₆H₅)SiOSi(CH₃)(C₆H₅)(CH═CH₂).

4. The active energy ray curable silicone composition according to claim 1, wherein component (B₂) is present and an organosiloxane oligomer represented by the following general formula:
HR³₂SiO(R³₂SiO)ₘSiR³₂H
wherein each R³ is independently an alkyl group or an aryl group, with the proviso that at least one R³ is an aryl group; and subscript m is an integer of 0 to 10.

5. The active energy ray curable silicone composition according to claim 4, wherein component (B₂) is at least one selected from organosiloxane oligomers represented by the following formulas:
H(CH₃)₂SiO(C₆H₅)₂SiOSi(CH₃)₂H; and
H(CH₃)₂SiO(C₆H₅)(CH₃)SiOSi(CH₃)₂H.

6. The active energy ray curable silicone composition according to claim 1, wherein the acryloxyalkyl group or methacryloxyalkyl group of component (D) is represented by the following general formula: 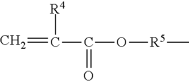
wherein R⁴ is a methyl group or a hydrogen atom; and R⁵ is an alkylene group having 2 to 6 carbon atoms.

7. The active energy ray curable silicone composition according to claim 1, wherein component (D) is at least one organosilicon compound selected from compounds represented by the following general formulas: 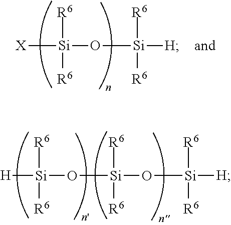
wherein each R is independently an alkyl group or an aryl group; X is a group represented by the following general formula: 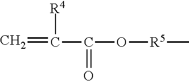
wherein R⁴ is a methyl group or a hydrogen atom, and R⁵ is an alkylene group having 2 to 6 carbon atoms; and subscript n is an integer of 1 to 10, subscript n′ is an integer of 1 to 10, and subscript n″ is an integer of 0 to 10.

8. The active energy ray curable silicone composition according to claim 1, wherein component (D) is used in an amount such that a content of the acryloxyalkyl group or methacryloxyalkyl group is 4 mmol/100 g or more relative to a total mass of components (A) to (E).

9. The active energy ray curable silicone composition according to claim 1, further comprising:
(F) a hydrosilylation reaction inhibitor, in an amount to adjust curing of the composition.

10. The active energy ray curable silicone composition according to claim 9, further comprising:
(G) a photoradical initiator, in an amount to accelerate curing of the composition by an active energy ray.

11. The active energy ray curable silicone composition according to claim 10, wherein component (D) is used in an amount such that a content of the acryloxyalkyl group or methacryloxyalkyl group is 4 mmol/100 g or more relative to a total mass of components (A) to (G).

12. The active energy ray curable silicone composition according to claim 1, further comprising:
(G) a photoradical initiator, in an amount to accelerate curing of the composition by an active energy ray.

13. A pre-cured product obtained by hydrosilylation reacting the active energy ray curable silicone composition according to claim 1.

14. A cured product obtained by exposing the pre-cured product according to claim 13 to an active energy ray.

15. A method of producing a cured product, the method comprising the following steps:
1) curing the curable silicone composition according to claim 1 to form a pre-cured product by hydrosilylation reaction;
2) placing the pre-cured product on a target substrate, and applying heat to and/or pressure onto the pre-cured product placed on a target substrate; and
3) exposing the pre-cured product to an active energy ray.
